(19) United States
(12) Patent Application Publication
(10) Pub. No.: US 2021/0205896 A1
(43) Pub. Date: Jul. 8, 2021

(54) Inner shaft machining tool

(71) Applicant: Koninklijke Luchtvaart Maatschappij N.V., Amstelveen (NL)

(72) Inventors: Mario Cornelis van Es, Rijpwetering (NL); Maarten Ottevanger, Rijpwetering (NL)

(73) Assignee: Koninklijke Luchtvaart Maatschappij N.V., Amstelveen (NL)

(21) Appl. No.: 17/059,226

(22) PCT Filed: May 24, 2019
(86) PCT No.: PCT/EP2019/063421

§ 371 Date: Nov. 26, 2020

(30) Foreign Application Priority Data
May 28, 2018 (EP) 18174581.1

(51) Int. Cl. B23B 29/034; B23B 29/02; B23Q 11/10; B23Q 17/22; B23Q 17/24

(52) U.S. Cl. CPC B23B 29/03489; B23B 29/027; B23Q 11/1023; B23B 2229/04; B23Q 17/2428; B23B 2215/76; B23Q 17/2266

(57) ABSTRACT

Machining tool for internal machining of a shaft (2) with an inner bore (3), such as an aircraft engine turbine shaft (fan mid shaft). The machining tool has an external boring bar (6) support device (5), and a boring bar (6) having a diameter smaller than a smallest opening on one side (4) of the inner bore (3) of the shaft (2). The boring bar (6) has a radially extensible cutting insert (7), and an end part (6b) of the boring bar (6) is rotatably connected to a main part (6a) of the boring bar (6). The end part (6b) is provided with one or more radially moveable guiding pads (8).

### FIELD OF THE INVENTION

The present invention relates to a machining tool for internal machining of a shaft with an inner bore, such as an aircraft engine turbine shaft.

### BACKGROUND ART

US patent publication U.S. Pat. No. 8,839,699 discloses a long shaft inner surface machining apparatus. A long shaft support device fixes a long shaft in order to prevent bending, the long shaft having an inner bore into which a machining head can be positioned axially using a head support device from one end of the long shaft. A blade drive device is coupled with the machining head from the other end of the long shaft to rotary drive a blade of the machining head. As the blade drive device and head support device are at opposite parts of the long shaft, this arrangement requires much space. Furthermore, the inner surface of the long shaft may be damaged by the support rollers of the support device, and it cannot be applied to axially varying diameter bores.

German patent publication DE-A-1086110 discloses a machining tool for internal machining of a shaft with an inner bore. The tool comprises a boring bar, a cutting insert, and an end part rotatable connected to a main part of the boring bar. An end part of the boring bar is provided with one or more radially moveable guiding pads.

US patent publication U.S. Pat. No. 6,394,710 discloses a tool having a base body on which at least one cutter holder, preferably a rocker-type cutter holder, is mounted such that it can be adjusted transversely with respect to the axis of the tool.

European patent publication EP-A-2136962 discloses a tool for working an internal bore, wherein a tube wear pad is used an pressed against the inside of a workpiece for pushing a spindle head against the opposing side.

US patent publication U.S. Pat. No. 8,839,699 discloses an apparatus to cut an inner surface of a long shaft, comprising a boring bar utilizing three or more sets of radially moveable free rollers that can rotate so as to permit and support movement in axial direction and rotation of the boring bar.

### SUMMARY OF THE INVENTION

The present invention seeks to provide an improved machining tool and machining method, which is particularly suited for machining an inner bore of an elongate shaft, even if the inner diameter profile of the inner bore comprises narrow openings on one or both sides of the shaft.

According to the present invention, a machining tool as defined above is provided, comprising an external boring bar support device, a boring bar having a diameter smaller than a smallest opening on one side of the inner bore of the shaft, the boring bar comprising a radially extensible cutting insert, and an end part of the boring bar rotatably connected to a main part of the boring bar, wherein the end part is provided with one or more radially moveable guiding pads. More specifically, a method is provided as defined in claim 1. This allows to very accurately machine the internal surface of an inner bore of an elongate shaft.

### SHORT DESCRIPTION OF DRAWINGS

The present invention will be discussed in more detail below, with reference to the attached drawings, in which

FIG. 1 shows a cross sectional view of a shaft having a profiled inner bore;

FIG. 2 shows a cross sectional view of an embodiment of the machining tool according to the present invention;

FIG. 3 shows a partial perspective view of a boring bar of an embodiment of the machining tool according to the present invention; and

FIG. 4 shows a schematic diagram of an embodiment of the machining tool according to the present invention

### DESCRIPTION OF EMBODIMENTS

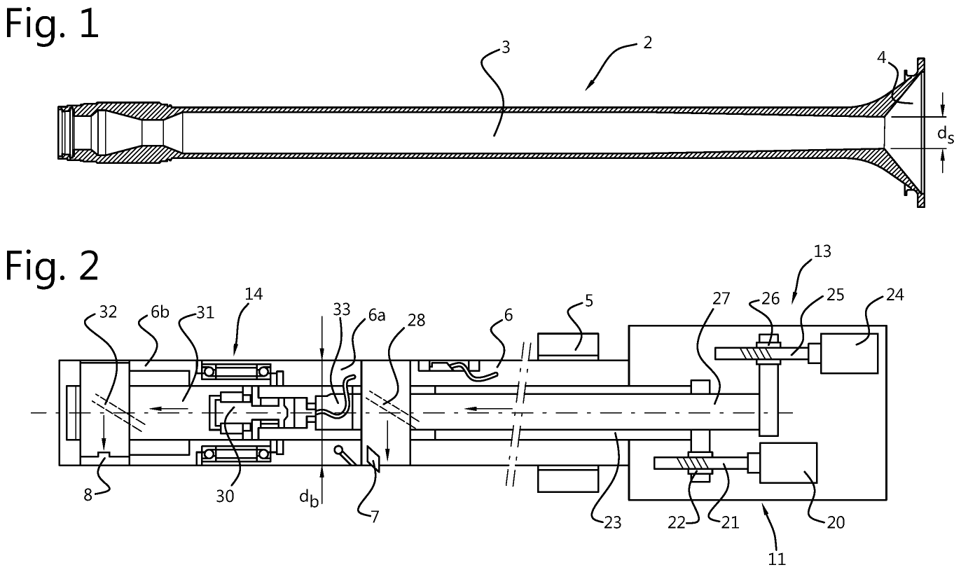

The present invention is discussed below with reference to a number of exemplary embodiments, and in general relates to machining of an inner bore of a shaft. Such a shaft with an inner bore is e.g. applied as an aircraft engine turbine shaft (fan mid shaft), more specifically to remove any possible internal corrosion in the shaft. FIG. 1 shows a cross sectional view of a shaft 2 having a profiled inner bore 3, which in this example has a restricted opening with diameter dₛ at one end 4 of the shaft 2. After prolonged use, the surface area of inner bore 3 may have internal corrosion. This corrosion must be removed per strictly regulated requirements as is customary in aircraft related maintenance. However, as a shaft 2 with corrosion cannot be assembled into an engine and, if no repair is available, must be declared scrap, the present invention embodiments would be beneficial especially for parties involved in aircraft engine maintenance, but also for aircraft operators. It is noted that the required machining operation to remove corrosion is turning, but because of poor accessibility of the internal areas of these type of shafts 2 the machining operation is far from straight forward. As shown in the example of FIG. 1, the inner bore 3 has varies sections, with possibly small opening diameters at one end, different sections with a cylindrical inner bore part or tapered inner bore part, and still a restricted opening with diameter dₛ complicating access to the long length inner bore 3.

Specific problems encountered when trying to machine the inner bore 3 of a shaft 2 are that a normal machining operation cannot be performed due to lack of proper and suitable tooling support. Without tooling support the required surface finish of the inner bore 3 and dimensional accuracy is impossible to meet. Because of this limitation a special machining tool has been developed, as described herein with reference to a number of exemplary embodiments.

Other factors that makes this type of machining operation hard to perform are that in certain applications, the material to be machined is very hard (e.g. hardened steel 54 HRc), and as mentioned above that the inner bore 3 of the shaft 2 has small diameter areas at both sides of the shaft 2, which hinders machining operation.

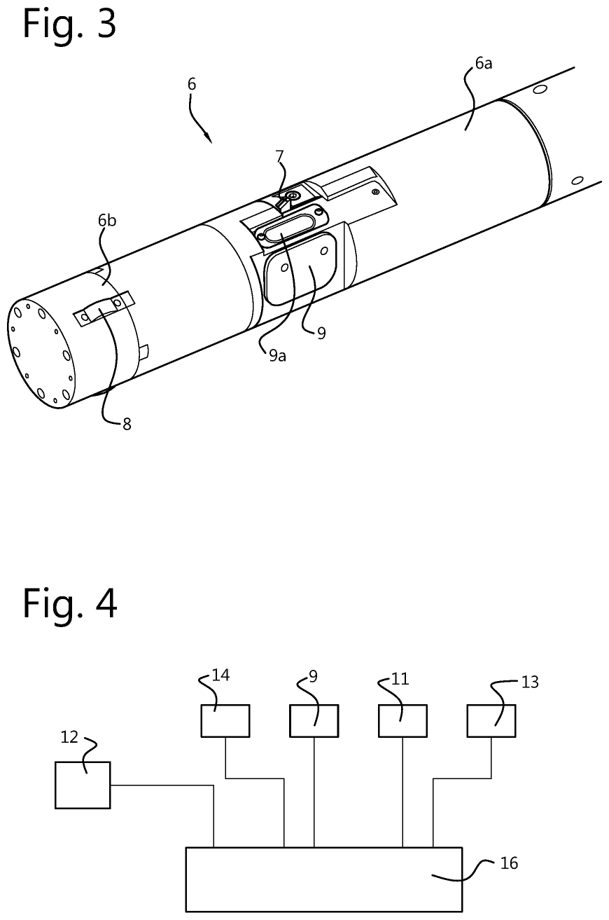

According to a first aspect of the present invention, a machining tool is provided for internal machining of a shaft 2 with an inner bore 3, wherein the machining tool comprises an external boring bar support device 5 and a boring bar 6 as shown in the cross sectional view of FIG. 2, and in the perspective partial view of FIG. 3. The boring bar 6 has a diameter d_{b} smaller than a smallest opening with diameter dₛ, see FIG. 1 above on one side 4 of the inner bore 3 of the shaft 2. Furthermore, the boring bar 6 comprises a radially extensible cutting insert 7, and an end part 6b of the boring bar 6 rotatably connected to a main part 6a of the boring bar 6. Lastly, the end part 6b is provided with one or more radially moveable guiding pads 8. Using the present invention machining tool, it is possible to access the inner bore 3 only from the one side 4, yet also have the boring bar 6 fully supported to allow precise machining. The external bar support device 5 may be e.g. implemented as a support bearing which during inserting and extracting of the boring bar 6 is held at a certain distance from the one end 4 of the shaft 2, i.e. remote from the cutting insert 7 (and end part 6a of the shaft 6). Such an external bar support device 5 prevents collision of the boring bar 6 with the smallest opening with diameter dₛ, see FIG. 1 above on one side 4 of the inner bore 3 of the shaft because the boring bar 6 could bend as much as at least 10 mm downwards due to its mass. The support pads 8 ensure that a required dimensional accuracy, runout accuracy and surface finish can be obtained by providing a rigid support of the shaft 2 during the machining operation. Lacking of a proper machining tool support can cause vibrations which would result in a poor surface finish.

It is noted that as shown in the exemplary embodiment of FIGS. 2 and 3, the boring bar 6 may comprise a main part 6a and an end part 6b, wherein the end part 6b of the boring bar 6 is rotatably connected relative to the main part 6a of the boring bar 6. The one or more radially moveable guiding pads 8 are configured to releasably clamp the end part 6b to the inner bore 3 of the shaft 2. As the radially extensible cutting insert 7 is provided on the main part 6a, this configuration allows to operate on the inner surface of the bore 3 in a very precise and controlled manner.

As the cutting insert 7 is radially extensible, the boring bar diameter d_{b} can be selected as high as possible for a specific type of shaft 2 with inner bore 3, in order to obtain sufficient rigidity over the long length of the shaft 2. In an exemplary embodiment, the operational machining length is 2130 mm, and a minimum diameter is 92 mm, so a ratio of operational machining length to diameter of the boring bar (6) can be in the order of 20 (more specifically 23), and is possibly within a range of 10-30.

By having the support pads 8 in the end part 6b of the boring bar 6, wherein the end part 6b can rotate with respect to the main part 6a of the boring bar 6, it is possible to have a non-rotating support of the machining tool (with respect to the surface of the inner bore 3). This also makes it possible to machine internal areas of the shaft 2 which otherwise cannot be machined at all with existing solutions. These support pads 8 can follow the internal diameter variation of the inner bore 3 in axial direction (e.g. using a continuously monitored extension pressure, see further below). Without these support pads 8 the boring bar 6 of a machining tool could bend as much as at least 10 mm downwards because of its mass. This makes machining impossible and causes collisions between the machining tool and the shaft 2.

Because of the rotating end part 6b of the boring bar 6, which holds the support pads 8 there is no damage of the internal surface of the inner bore 3 of the shaft 2. The support pads 8 are only sliding in an axial direction with respect to the internal surface of the inner bore 3. In further exemplary embodiments, the end part 6b is provided with at least three radially moveable guiding pads 8, e.g. at 120° intervals (i.e. evenly distributed around the circumference of the end part 6b). This allows a precise axial alignment of the boring bar 6 in the inner bore 3. The guiding pads 8 may comprise a plastic material, even further lessening the chance of damage to the inner bore 3.

In a further embodiment, the main part 6a of the boring bar 6 is connected to an axial drive unit 11, to allow machining (and measurement) along a large part of the inner bore 3 by moving the boring bar 6 left and right in the inner bore 3. The axial drive unit 11 may be implemented in various manners, of which one example is shown in the embodiment shown in FIG. 2. Here, the axial drive unit comprises a motor 20 connected to a rotating axis 21 provided with a worm wheel 22. The rotation of the worm wheel 22 causes translational (left and right) motion of a connecting element 23 fixed to the boring bar 6 (supported by external boring bar support device 5).

The cutting insert 7 as shown in the FIGS. 2 and 3 exemplary embodiments is controlled to follow a pre-programmed path when the boring bar 6 moves in axial direction during use. Because of this feature, the diameter d_{b} of the boring bar 6 of the machining tool can be made as large in diameter and as rigid as possible. As mentioned above, rigidity of the machining tool is a key feature for a successful machining operation. To this end, in a further aspect of the present invention, a method of operating the machining tool according to any one of the embodiments described herein is provided, the method comprising machining the inner bore 3 according to a predetermined machining profile by adjusting the cutting diameter of the radially extensible cutting insert 7 as function of an axial position of the radially extensible cutting insert 7. Precise control may be obtained in various control system embodiments, e.g. using a computer numerical control (CNC) unit.

It is noted that internal diameters cannot be measured with conventional inspection tooling of a shaft 2 with an inner bore 3. Visibility before, during and after the machining operation might even require custom made vision equipment, and required minimum surface finish may require custom made surface finish measurement tooling. To address these issues, in a further embodiment, the main part 6a of the boring bar 6 further comprising an inner bore diameter measurement device 9, axially positioned near to the radially extensible cutting insert 7. As an example, the inner bore diameter measurement device 9 is a laser based measurement device 9, as shown in the partial perspective view of FIG. 3.

As shown in the embodiment of FIG. 3, the laser based measurement device 9 is co-located with cutting insert 7 in the main part 6a of the boring bar 6, and using a laser beam directed away from the boring bar 6 as indicated by the solid line. The laser based measurement device 9 can be built in the boring bar 6 of the machining tool, e.g. as shown in FIG. 3 in a dedicated cavity within the main part 6a of the boring bar 6. The inner bore measurement device 9 is arranged for measuring a distance, which can be recalculated to determine an axial profile of inner bore 3.

The inner bore diameter measurement device 9 may comprise a protection cover 9a as shown in FIG. 3 embodiment, in order to protect the (sensitive) electronic and optical components from the environment during turning, such as a cooling liquid.

In operation, the (build-in laser) inner bore diameter measurement device 9 measures the internal diameter before and after the machining operation at programmable locations in a further method embodiment of the present invention. Conventional inspection tools to determine internal diameters are not useable.

To this end, the method embodiment as described above, may further comprise measuring an inner bore axial diameter profile before and/or after the machining of the inner bore 3. The measurement before machining can be used to determine an initial profile, match it with a desired profile and determine where e.g. internal corrosion is present. However this is optional, the machining can also be executed using a pre-stored profile. The measurement after machining can then be used to check whether the inner bore 3 is within desired specifications.

In a further embodiment, measuring comprises measuring the inner bore axial diameter profile at a plurality of predetermined axial locations along the inner bore 3. When taking sufficient measurements, or using known parameters of the inner bore 3 profile (e.g. number of straight, tapered, and/or complex form sections of the inner bore 3), it is possible to determine a proper inner bore axial diameter profile.

In an even further embodiment, the method may comprise converting the measured inner bore axial diameter profile to a predetermined machining profile. Such a predetermined machining profile may then e.g. be used for batch processing of a number of shafts 2 in sequence.

The CNC unit may be implemented as a single unit, or as a combination of separate control units (possibly interconnected). This allows to be able to work with tapered diameters of the inner bore 3 and smooth transitions between non-machined and machined areas, possibly using custom made CNC control software.

The radially extensible cutting insert 7 is remotely controlled by a (numerically controlled) cutting diameter setting unit 13 in a further embodiment. An implementation thereof is shown in the cross sectional view of FIG. 2, wherein the cutting diameter setting unit 13 comprises a motor 24 rotationally driving an axis 25 provided with a worm wheel unit 26. This provides translation movement of a rod 27, which translational movement is converted in a radially extending movement of the cutting insert 7 by a conversion unit 28, as indicated by the arrows.

In a further embodiment, the radially moveable guiding pads 8 are remotely controlled by a (numerically controlled) guiding pad diameter setting unit 14. In the embodiment shown in cross section in FIG. 2, the guiding pad diameter setting unit 14 comprises a number of components, of which the majority is located in the end part 6b of the boring bar 6. In this embodiment, an electric actuator 30 is arranged to move a connecting rod 31 in axial direction (arrow to the left), and via a converter element 32, radially extend the guiding pads 8 (arrow towards guiding pad 8). The electric actuator 30 is driven via an electric wire 33 which is guided through the internal area of the boring bar 6.

The guiding pad diameter setting unit 14 may further be provided with a torque sensing device in a further embodiment, e.g. at one or more of the radially moveable guiding pads (8). This allows to arrange for a feedback control loop for accurately keeping the boring bar 6 centred within the inner bore 3 during operation.

Alternatively or additionally, the radially moveable guiding pads, or components thereof, may be fitted with force sensors, allowing a continuously monitored extension pressure of the guiding pads 8 (again e.g. using a feedback control loop).

For operational control of the machining tool, a tool control unit 16 is provided in a further embodiment, which is connected to the optionally present axial drive unit 11, cutting diameter setting unit 13, guiding pad diameter setting unit 14, and/or inner bore diameter measurement device 9. This exemplary set-up is shown in the schematic diagram of FIG. 4.

It is noted that for the machining operation, the shaft 2 may be rotationally driven, i.e. in a circumferential direction, while the boring bar 6 is only axially moving, and not rotating. To this end, the machining tool may further comprise a rotational drive unit 12 (possibly connected to and controlled by the tool control unit 16).

With machining of an inner bore 3 of a shaft 2, it is possible that produced metal chips and/or further debris will collect inside the shaft 2 and these must be removed before these can disturb the machining operation or damage the machined areas. In a further embodiment of the present invention machining tool, coolant, required for machining, is flushed backward thus preventing being entrapped between guiding pads 8 and inner surface of the inner bore 3 of the shaft 2 which could otherwise result in damages of the inner surface. Construction wise, the machining tool may further comprise a coolant supply device arranged to flush a coolant liquid during operation in a direction from the guiding pads (8) to the radially extensible cutting insert (7), i.e. towards the one end of the inner bore 3.

The present invention has been described above with reference to a number of exemplary embodiments as shown in the drawings. Modifications and alternative implementations of some parts or elements are possible, and are included in the scope of protection as defined in the appended claims.

1. A machining tool for internal machining of a shaft with an inner bore, comprising an external boring bar support device,
a boring bar configured to have a diameter smaller than a smallest opening on one side of the inner bore of the shaft to be machined internally, the boring bar comprising a radially extensible cutting insert, and
an end part of the boring bar rotatably connected to a main part of the boring bar, wherein the end part is provided with one or more radially moveable guiding pads which are remotely controlled by a guiding pad diameter setting unit, and wherein the radially extensible cutting insert is remotely controlled by a cutting diameter setting unit.

2. The machining tool according to claim 1, wherein the end part is provided with at least three radially moveable guiding pads.

3. The machining tool according to claim 1, wherein the guiding pads comprise a plastic material.

4. The machining tool according to claim 1, the main part of the boring bar further comprising an inner bore diameter measurement device, axially positioned near to the radially extensible cutting insert.

5. Them machining tool according to claim 4, wherein the inner bore diameter measurement device is a laser based measurement device.

6. The machining tool according to claim 4, wherein the inner bore diameter measurement device comprises a protection cover.

7. The machining tool according to claim 1, further comprising a coolant supply device arranged to flush a coolant liquid during operation in a direction from the guiding pads to the radially extensible cutting insert.

8. The machining tool according to claim 1, wherein the guiding pad diameter setting unit is provided with a torque sensing device.

9. The machining tool according to claim 1, further comprising a tool control unit, connected to the each of the axial drive unit, cutting diameter setting unit, guiding pad diameter setting unit, and/or inner bore diameter measurement device if present.

10. The method of operating the machining tool according to claim 1,
the method comprising machining the inner bore according to a predetermined machining profile by remotely controlling the one or more radially moveable guiding pads and by remotely controlling adjustment of the cutting diameter of the radially extensible cutting insert s function of an axial position of the radially extensible cutting insert.

11. The method according to claim 10, further comprising measuring an inner bore axial diameter profile before and/or after the machining of the inner bore

12. The method according to claim 11, wherein measuring comprises measuring the inner bore axial diameter profile at a plurality of predetermined axial locations along the inner bore.

13. The method according to claim 12, further comprising converting the measured inner bore axial diameter profile to a predetermined machining profile.
